(19) United States
(12) Patent Application Publication
(10) Pub. No.: US 2016/0102879 A1
(43) Pub. Date: Apr. 14, 2016

(54) USING A DATABASE SYSTEM TO CAUSE AUTOMATED SYSTEM EVENTS TO BE PERFORMED IN RESPONSE TO ENVIRONMENTAL SENSING

(71) Applicant: salesforce.com, inc., San Francisco, CA (US)

(72) Inventors: Ryan Guest, Stockton, CA (US); Swaroop Shere, Dublin, CA (US); Reid Scott Carlberg, La Grange, IL (US)

(21) Appl. No.: 14/684,803

(22) Filed: Apr. 13, 2015

Related U.S. Application Data
(60) Provisional application No. 62/063,297, filed on Oct. 13, 2014.

(51) Int. Cl. F24F 11/00; G05B 15/02

(52) U.S. Cl. CPC F24F 11/006; G05B 15/02

(57) ABSTRACT

Examples of database systems, apparatus, methods and computer program products are disclosed for causing automated system events to be performed in response to environmental sensing. In some implementations, a database system can receive environmental data and location data from a computing device capable of reading environmental data using an environmental sensor. The sensor is situated at a geographic location identified by the location data. An occurrence of an environmental condition can be determined using the environmental data. A database record in a database can be created or updated to identify the environmental data and/or the environmental condition. A system event to perform can then be determined based on the creating or updating of the database record.

### PRIORITY DATA

This patent document claims priority under 35 U.S.C. §119 to co-pending and commonly assigned U.S. Provisional Patent Application No. 62/063,297, titled “Automated Case Creation From Temperature Reading”, by Guest et al., filed on Oct. 13, 2014 (Attorney Docket No. 1200.1527PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to environmental sensing and control. More specifically, this patent document discloses techniques for using a database system for performing automated events in relation to environmental sensing.

### BACKGROUND

“Cloud computing” services provide shared network-based resources, applications, and information to computers and other devices upon request. In cloud computing environments, services can be provided by servers to users' computer systems via the Internet and wireless networks rather than installing software locally on users' computer systems. A user can interact with social networking systems, by way of example, in a cloud computing environment.

The “Internet of Things” (IoT) refers to the connectivity, using a combination of the Internet and various wired and/or wireless networks, of various devices, appliances, machines and other physical objects or “things” embedded with electronics, software and communications interfaces. By using such connections, users can remain in communication with things through their computer systems such as smartphones or tablets. For example, things can exchange data with their manufacturer, operator and/or connected devices. Generally, each thing is uniquely identifiable and is able to interact with other things in an existing network infrastructure.

### BRIEF DESCRIPTION OF THE DRAWINGS

The included drawings are for illustrative purposes and serve only to provide examples of possible structures and operations for the disclosed inventive systems, apparatus, methods and computer program products for using a database system to cause automated system events to be performed in response to environmental sensing. These drawings in no way limit any changes in form and detail that may be made by one skilled in the art without departing from the spirit and scope of the disclosed implementations.

FIG. 1 shows a block diagram of an example of a database system 100 and related hardware for automatically causing one or more system events to be performed in response to environmental sensing, in accordance with some implementations.

FIG. 2 shows a flowchart of an example of a method 200 for using a database system to automatically cause one or more system events to be performed in response to environmental sensing, in accordance with some implementations.

FIG. 3 shows an example of a group page 300 of an enterprise social networking system in the form of a graphical user interface (GUI) as displayed on a user system, in accordance with some implementations.

FIG. 4 shows an example of a tasks list 400 of a tasks app in the form of a GUI as displayed on a user system, in accordance with some implementations.

FIG. 5 shows an example of a temperature monitoring window 500 with dashboard components in the form of a GUI as displayed on a user system, in accordance with some implementations.

FIG. 6 shows an example of an interactive map 600 of a floor of an office building in the form of a GUI as displayed on a user system, in accordance with some implementations.

FIG. 7 shows a flowchart of an example of a method 700 for using a database system to automatically cause one or more system events to be performed in response to temperature sensing, in accordance with some implementations.

FIG. 8 shows an example of a database record in the form of a case 800 as presented in a GUI displayed on a user system, in accordance with some implementations.

FIG. 9A shows a block diagram of an example of an environment 10 in which an on-demand database service can be used in accordance with some implementations.

FIG. 9B shows a block diagram of an example of some implementations of elements of FIG. 9A and various possible interconnections between these elements.

FIG. 10A shows a system diagram of an example of architectural components of an on-demand database service environment 900, in accordance with some implementations.

FIG. 10B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured for using a database system to perform or cause the performance of automated system events in response to environmental sensing.

The growing popularity of cloud computing and software as a service (SaaS) contributes to development of software and/or hardware platforms for businesses and other enterprises that provide cloud-based products and services in addition to data storage and management solutions. By way of example only, salesforce.com, inc., of San Francisco, Calif., offers a number of customer relationship management (CRM) products and services that are cloud-based solutions upon which relevant applications can be launched and/or built for any enterprise. In some but not all implementations, such platforms can be integrated with data storage and management services of a multi-tenant database system.

In some of the disclosed implementations, database systems can be used to enable and facilitate work-related computing events and user actions, for instance, pertaining to a workplace environment such as an office building or factory. Some of the disclosed techniques can be applied to control various devices, smart appliances, machines and systems commonly installed or located in a workplace environment, such as a thermostat and/or heating, ventilating and air conditioning (HVAC) system, a humidifier, a lighting control and/or lighting system, switches, a refrigerator, etc. In some implementations, temperature, light, humidity and/or other environmental characteristics of a physical environment such as an office conference room can be monitored using an appropriate array of environmental sensors. A database record can be created or updated when certain environmental conditions are detected. Any of various system events can be performed or scheduled to be performed in response to the database record update, and various user actions can be taken in relation to the environmental conditions and/or to the database record.

For example, when the temperature is determined to be too high on a floor of an office building, a database system can be used to cause a signal to be sent over an appropriate communications channel to a smart thermostat and/or smart lighting control system to reduce the temperature and/or turn off the lights. In another example, a humidity sensor can indicate that a climate in a greenhouse is too dry, causing an appropriate database record to be created, in turn causing a signal to be sent instructing a smart humidifier in the greenhouse to turn on. Also or alternatively, if the greenhouse is too hot and/or too bright from too much sunlight, a database record can be generated, which causes electronic shades or blinds in the greenhouse to be lowered, for instance, using a commercially available environmental control system such as Nest™.

In some other implementations, creating or updating a database record in response to detecting an environmental condition can cause an email or social media message to be sent to one or more workers or security personnel located in a building. Security systems can, in turn, be updated to provide security clearance for those individuals to use their security badges to access certain regions of a building in which a thermostat, HVAC system, lighting system, etc. is located, so an individual can personally inspect a system and/or make manual adjustments.

In one example, some of the disclosed techniques are implemented to interact with things in the IoT of a specific area of a floor of an office building owned by Acme, Inc. The HVAC system of this Acme office building has not been updated in decades, and many people around the building often complain on social network feeds throughout the workday that it is too hot or too cold. Often, at a given time, people located on the east side of the building complain that the temperature is in the 50's, while people on the west side complain that the temperature is in the 80's. Various temperature sensors can be deployed on all of the building floors and on the east, west, north and south sides of each floor. Temperature data from the various sensors can be gathered and communicated to a server of a database system providing CRM and other services.

When a server determines that a temperature reading from a sensor located on the west side of the 3^{rd} floor of the Acme building is too high, for instance, exceeding a threshold of 80 degrees Fahrenheit, the server can create or instruct another server to create a CRM record in the form of a case linked with an Acme, Inc. account. In this example, a separate case is created each time the temperature traverses a threshold, such as the temperature being higher than 80 degrees or lower than 60 degrees. Each case is populated with data to indicate the temperature reading, the time of the reading, the region and floor of the Acme building and other data. A record update informing the creation of the record is then published to a social network feed. This notification can be shared, for instance, with employees in a workgroup having offices and workstations located on the 3^{rd} floor. A user can use a smartphone to tap the record update in the user's news feed and click through to a graphical presentation of the case on the user's smartphone. The user can also publish commentary on one or more relevant feeds regarding the case.

In this example, a communication channel configured between the server and a temperature or HVAC controller, such as a smart thermostat located on the west side of the 3^{rd} floor, can be used by a server of the database system to send commands to activate or regulate the air conditioner to decrease the temperature. Thus, the temperature may be monitored and controlled to be within a desirable range for particular geographic locations using cases created and managed in a database system.

In some implementations, a computing device in communication with a temperature sensor at a particular location reads temperature data and communicates the temperature data via an application programming interface (API) request to the server along with data identifying the location at which the sensor is deployed. In some implementations, a new case is populated with temperature data informing the particular temperature reading and timestamps indicating approximately when the reading was made and when the case was created. In this way, each case is linked with a particular reading. Thus, users viewing the case, for instance, using a CRM and/or social networking platform, can quickly see the time that lapsed since the reading was made. The case is also populated with location data linking the case with a specific geographic region or location, for instance, in the form of metadata with GPS coordinates which define the location. A related list of cases can be identified to link all readings from a particular sensor or geographic location. In some but not all implementations, environmental data, location data and timestamps associated with environmental readings are maintained for a given organization such as Acme, Inc. in a multi-tenant database system, with Acme being one of any number of tenants for which data is organized, stored and maintained.

In one example, when salesforce.com's CRM platform is used, standard case objects can contain or identify one or more types of data, such as environmental data, location data, a timestamp, or other relevant data. For example, one or more of such data types can be inserted in a description field of the case object. Customized rules can be configured to determine when a case is created as well as to determine when cases are escalated and de-escalated. Thus, for instance, at any time when temperature data from a given sensor is determined to be outside of a range such as 65-75 degrees Fahrenheit, a case is created with a description field including metadata details of the time and location of a temperature reading.

In some implementations, system events can be automatically performed or automatically scheduled to be performed in response to case creation. Case management and enterprise social networking tools can be used to relay messages to office personnel, security staff, vendors, and other relevant individuals who may wish to comment on and/or personally deal with the detected environmental condition. For example, an email can be generated and sent to a third party vendor or an internal employee to request that the individual take some action, such as accessing the case using his or her smartphone, communicating with others about the situation, etc.

A CRM hierarchy can be implemented to organize cases under appropriate accounts. In one example, a separate account represents each office building owned or rented by a parent organization, such as Acme, Inc. Thus, at least a street address of a particular office building can be identified immediately after a case is created.

While environmental monitoring and control systems are often referred to herein for purposes of illustration, the disclosed techniques are not limited to such contexts. For example, sensing and actuation systems can be controlled to optimize energy consumption. Any form of electrical or energy consuming/controlling device or apparatus such as a switch, power outlet, light bulb, television, monitor, speaker, etc. can be controlled. Using some of the disclosed techniques, things in the IoT can be used to monitor and control the mechanical and electrical systems used in various types of buildings including those considered public, private, industrial, institutional, or residential. Environmental characteristics such as lighting, heating, ventilation and air conditioning can be controlled, as can appliances, communication systems, entertainment systems, home security systems and devices.

Electronic notifications of database record creations or updates, generated using the disclosed techniques, can be communicated to a utility supply company for events to automatically be performed to effectively balance power generation and energy usage. Informed individuals can be provided with instructions and permission to remotely control relevant devices and systems, and centrally manage them via a cloud based interface. System events like remotely powering on or off heating systems, controlling humidifiers, changing lighting conditions, etc. can be performed immediately or at scheduled times. Notifications generated in response to database record creations or updates can be used to gather and act on energy and power-related information in an automated fashion with the goal of improving the efficiency, reliability, economics, and sustainability of the production and distribution of electricity.

Some but not all of the techniques described or referenced herein are implemented using a social networking system. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. In some but not all implementations, these various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described below. The information updates can include various social network data from various sources and can be stored in a database system. In some but not all implementations, the disclosed methods, apparatus, systems, and computer program products may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail below, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned below, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail below. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

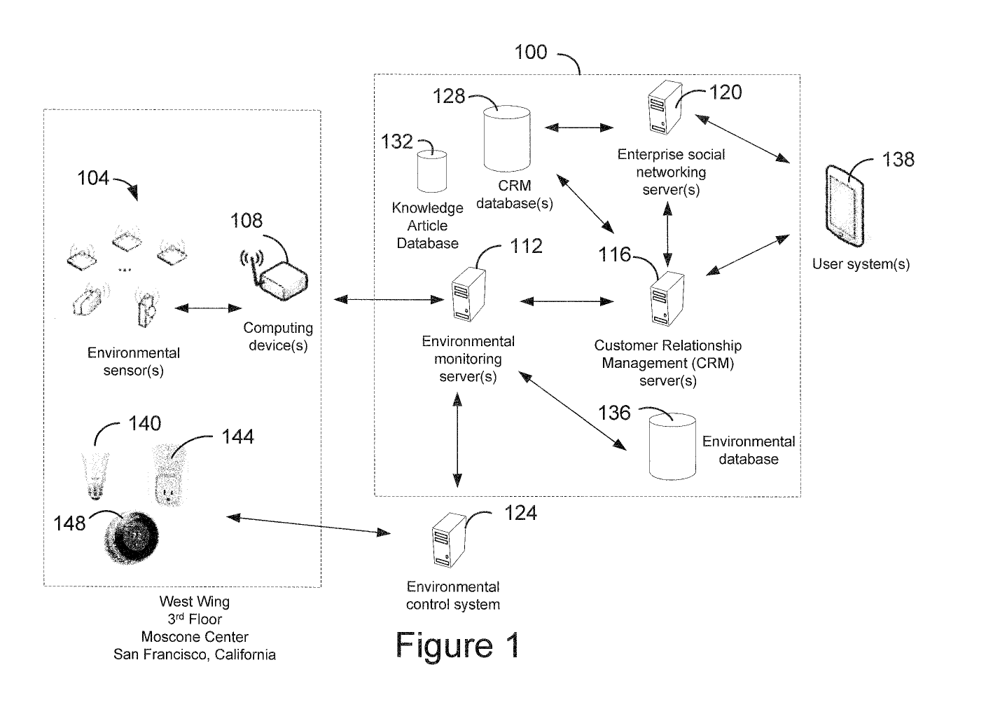

FIG. 1 shows a block diagram of an example of a database system 100 and related hardware for automatically causing one or more system events to be performed in response to environmental sensing, in accordance with some implementations. In FIG. 1, any number of environmental sensors 104 are located on the west wing of the 3^{rd} floor of Moscone Center, an office building located in San Francisco, Calif. Environmental sensors 104 in this example include separate temperature, light and humidity sensors. Sensors 104 are in communication with one or more computing devices 108. In some implementations, each sensor is in communication with a respective computing device, while in some other implementations, one computing device supports multiple sensors. In one example, a computing device 108 is physically located near the sensor(s) the device supports, for instance, within 100 feet. Location data maintained at a computing device 108 and/or at a server in communication with the computing device identifies the geographic location of the sensor(s) supported by that computing device, such as west wing, 3^{rd} floor, Moscone Center. A computing device 108 is programmed with software instructions to read environmental data from a sensor. For example, the Python programming language may be used to create a routine for reading temperature data.

By way of illustration, a digital temperature sensor, such as an Adafruit® temperature sensor is connected to a mobile computing device 108, such as a Raspberry Pi® board or an Arduino® board. Those skilled in the art will appreciate how to implement a circuit to connect the temperature sensor to the Raspberry Pi® or Arduino® board and to configure the board to read the sensor data with suitable program instructions. Raspberry Pi®, by way of example, has a general purpose input/output (GPIO) to drive an analog environmental reading or a digital environmental reading to digital data. The Raspberry Pi® board also provides Wi-Fi coordinates, which can sever as location data of a sensor in communication with the board. For instance, a first set of sensors can be labeled “Moscone East”, while another set of sensors are labeled “Moscone West” according to their geographic regions in the building. In another example, each environmental sensor can have a unique key linked with a uniquely identifiable location using Wi-Fi coordinates. Thus, the key of a sensor located in the east wing can be mapped to a specific floor and room on the floor in that region.

In the example of FIG. 1, one or more computing devices 108 communicate with an environmental monitoring server 112 of database system 100. For example, the Raspberry Pi® boards are Wi-Fi enabled and configured to communicate over Hypertext Transfer Protocol (HTTP) to one or more servers of system 100. In the example of FIG. 1, environmental monitoring server 112 is configured with cloud-based applications for monitoring and processing environmental data provided by computing devices 108. Any appropriate interface, such as salesforce.com's REST API, can be provided by environmental monitoring server 112. In some implementations, the salesforce REST API provides an endpoint and the key or designation for each computing device and the respective sensor supported by that computing device in the form of a unique ID.

In the example of FIG. 1, database system 100 includes several servers, each of which is dedicated to performing different operations of some implementations of the disclosed techniques. In this example, the servers of system 100 include one or more environmental monitoring servers 112 in communication with computing devices 108, one or more CRM servers 116 in communication with an environmental monitoring server 112 and one or more enterprise social networking servers 120 in communication with a CRM server 116. The operations and services provided by different servers 112, 116 and 120 in the example of FIG. 1 are, in some other implementations, performed by a single server. That is, servers 112, 116 and 120 can be implemented as different processing modules of the same server. By the same token, operations described herein as being performed by the same server, such as enterprise social networking server 120, can be distributed among any number of servers.

In the example of FIG. 1, an environmental control system 124 is represented as a server in communication with environmental monitoring server 112. However, in this example, environmental control system 124 is not part of database system 100. In some other implementations, an environmental control system is one component of system 100. Also, in some other implementations, one or more of servers 112, 116 and 120 are part of a different system than database system 100. For example, CRM server 116 and enterprise social networking server 120 may be managed by or on behalf of a first provider, while environmental monitoring server 112 and environmental control system 124 are provided by a different provider.

In FIG. 1, database system 100 further includes one or more CRM databases 128 in communication with CRM server 116 and enterprise social networking server 120. A CRM database 128 is managed by CRM server 116 to store, update and otherwise maintain CRM data objects including various cases, accounts, opportunities, leads, contacts, contracts, etc. An enterprise social networking system such as Chatter® can access and generate feed items of a social network feed including or referencing CRM data stored in database 128. In the example of FIG. 1, database system 100 further includes a knowledge article database 132, which stores knowledge articles for use by one or more servers of database system 100. In FIG. 1, one or more environmental databases 136 are provided to store environmental data and related data received by, processed and/or generated by environmental monitoring server 112. This data in database 136 can thus be retrieved and used to send commands to various systems and devices such as environmental control system 124.

In FIG. 1, one or more user systems 138 such as tablets, smartphones, laptops, wearable display devices, etc. can be carried and operated by users to interact with database system 100. For example, a user system 138 can be operated by an individual to access enterprise social networking server 120 to view social network feeds. By the same token, a user can pull up CRM records for display by using user system 138 to send commands to CRM server 116. Any of the various user interfaces described herein and illustrated in the Figures can be generated and displayed on a user system 138.

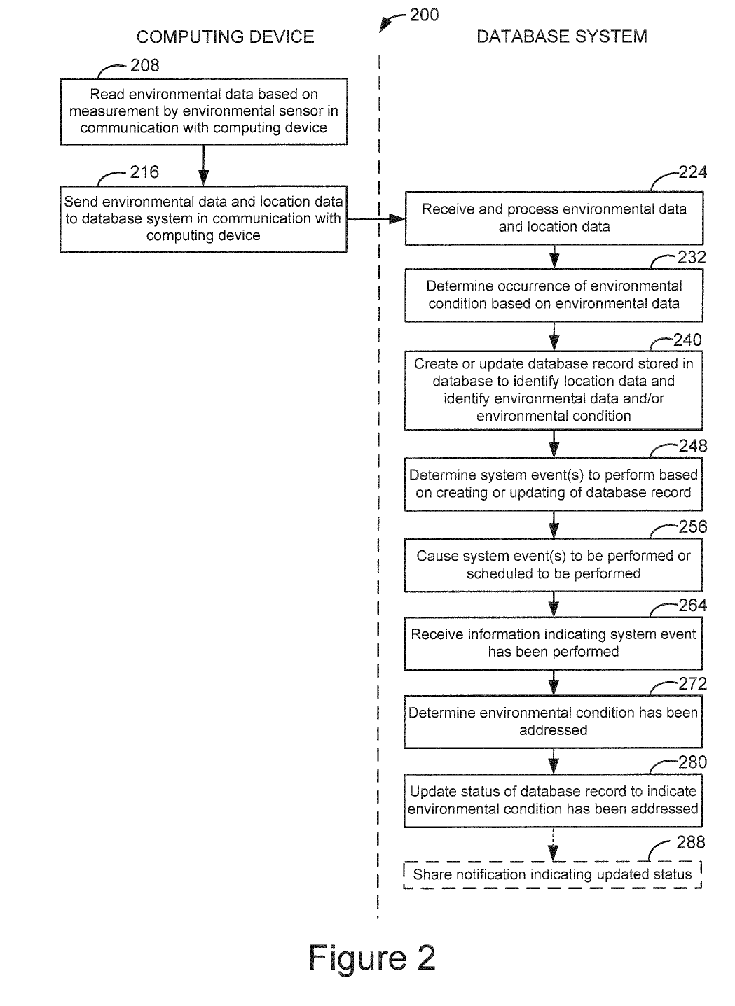

FIG. 2 shows a flowchart of an example of a method 200 for using a database system to automatically cause one or more system events to be performed in response to environmental sensing, in accordance with some implementations. Method 200 is described in relation to the non-limiting example of FIG. 1 for purposes of illustration. At 208 of method 200, a computing device 108 reads environmental data based on a measurement or measurements by one or more environmental sensors 104. At 216, computing device 108 sends the environmental data of 208 as well as location data to one or more servers of database system 100. For example, such data can be transmitted to environmental monitoring server 112 of FIG. 1. The location data transmitted at 216 identifies a geographic location of environmental sensor or sensors 104. For example, the location data can be in the form of Wi-Fi coordinates, global positioning system (GPS) coordinates, a network address, a street address, a floor of a building and/or a region of a building.

In FIG. 2, at 224, environmental monitoring server 112 receives and processes the environmental data and location data received from computing device 108. At 232 of FIG. 2, as part of the processing of data received from computing device 108, environmental monitoring server 112 determines that an environmental condition has occurred based on the environmental data. For example, when humidity data is outside of a specified range of acceptable humidity levels, it can be determined at 232 that the humidity is too high or low and thus should be regulated. The thresholds and/or ranges used at 232 are customizable, for example, by a system administrator, as is how often environmental data is read using one or more sensors 104.

Environmental data, location data and/or environmental conditions detected at 224 and 232 of FIG. 2 can be stored in environmental database 136 by environmental monitoring server 112. Also or alternatively, at 240, environmental monitoring server 112 can send a command, the data and the detected condition to CRM server 116 for CRM server 116 to create or update a database record in CRM database 128. In this example, a CRM record in database 128 can be created or updated to identify the location data as well as the environmental data and/or environmental condition of 224 and 232. For example, the database record can be in the form of a case having a child-parent relationship with a parent record such as an account identifying a specific organization, a building, a street address, a city, a state and/or a geographic region.

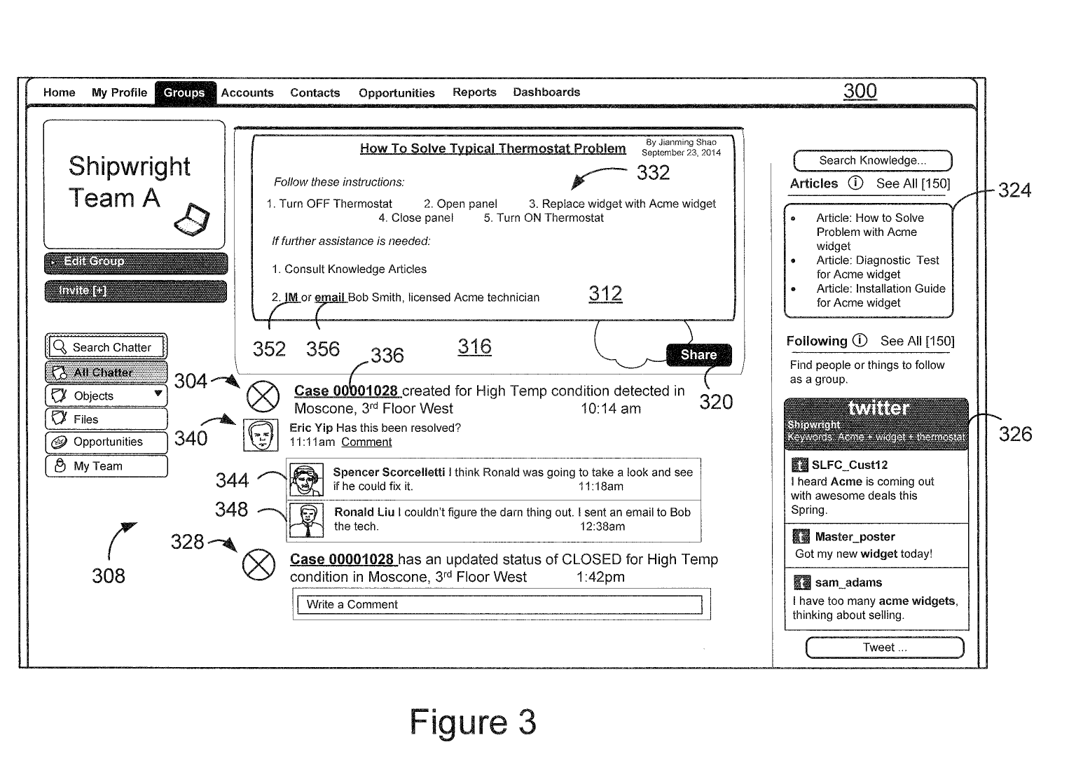

In FIG. 2, at 248, one or more servers of database system 100 of FIG. 1 are configured to determine one or more system events to perform in response to the creating or updating of a database record at 240. A server in such a system can perform or cause other servers to perform system events or related processing. One example of a system event is the identification of one or more users as being relevant to the geographic location corresponding to the location data and/or relevant to the environmental condition recorded in a database record at 240. FIG. 3 shows an example of a group page 300 of an enterprise social networking system in the form of a graphical user interface (GUI) as displayed on a user system, in accordance with some implementations. In FIG. 3, members of the Shipwright Team A group have offices and cubes located in the west wing on the 3rd floor of Moscone Center and are thus identified at 248 of FIG. 2. In FIG. 3, a record update 304 informing members of Team A that a high temperature condition has been detected is published to a group feed 308 dedicated to Shipwright Team A. Various categories of users and other individuals can be identified as being located at or having an interest in a specific geographic location. For example, an off-site manager, vendor, or security officer can be identified at 248 of FIG. 2 as an individual to notify in response to an environmental condition being detected.

Additional examples of system events include the sharing of notifications with various users and individuals of the creating or updating of a database record. For example, in addition to or as an alternative to the publishing of a feed item in a feed, mobile computing notifications such as push notifications to a smartphone or tablet, emails, or instant messages (IMs) can automatically be generated and transmitted to affected employees in a specific location of a building or to other individuals who may be in a position to remedy a situation. Also or alternatively, automatic posts can be generated and shared on an individual's wall or news feed of a social networking system. Desirably, such notifications include information relevant to the environmental condition, such as the specific geographic location and any hardware information that may be helpful to addressing a problem. For example, if the temperature in a specified location is outside of a desired range, data stored in the resulting database record can be communicated to a designated vendor so the vendor can immediately find and address the problem.

Another example of a system event capable of being determined at 248 of FIG. 2 is the identification of knowledge articles relevant to a database record created or updated at 240. For example, in FIG. 3, the content of a frequently-accessed knowledge article 312 identified as being relevant to an environmental condition, such as a high temperature condition, is automatically loaded in a publisher 316 of page 300. In this way, a user viewing publisher 316 can quickly access relevant information to address a problem as well as click or tap a share button 320 to publish article 312 in a feed. In FIG. 3, additional articles identified as being possibly relevant to a high temperature condition are identified in an articles window 324. In this way, a user can click on a title of an article in window 324 to cause part or all of the content of the selected article to be displayed in a pop-up window or loaded in publisher 316 similar to article 312. Knowledge articles can be automatically identified using keyword searching and/or a topical index, for example, where articles relevant to thermostats are automatically linked with the word “temperature” and other terms. Other information from additional social networking systems and/or other web-based resources can be similarly identified in window 326.

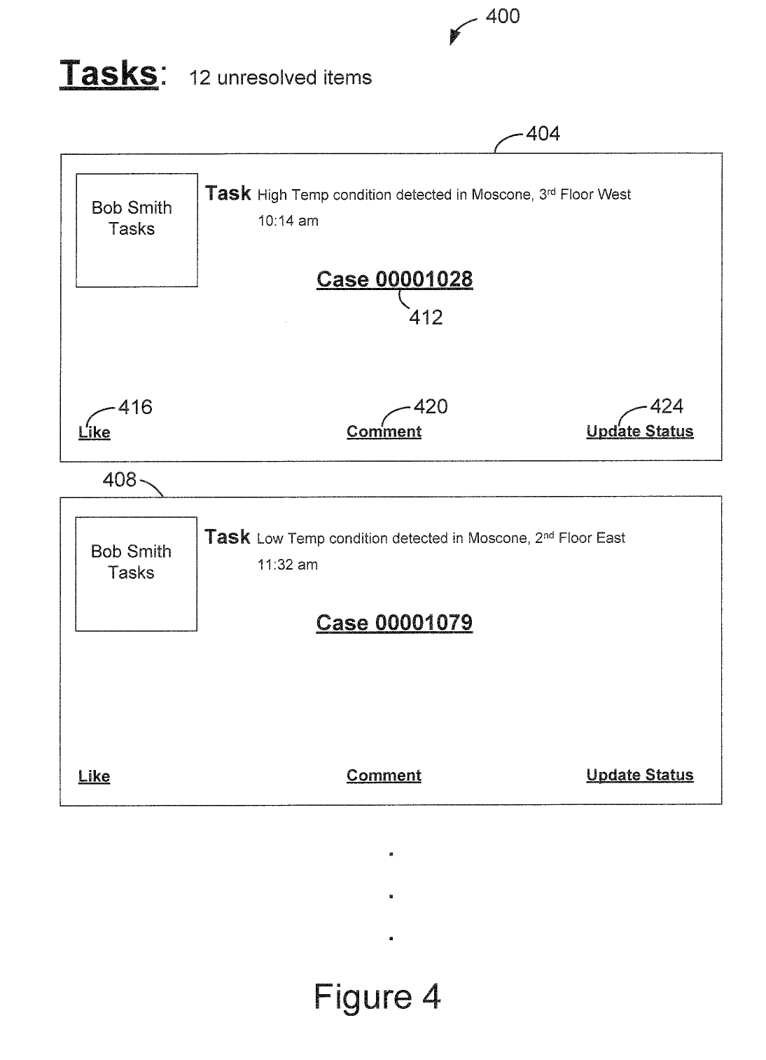

Another example of a system event capable of being determined at 248 of FIG. 2 is the determining and/or generating of tasks associated with the database record, as well as the assignment of such tasks to relevant users. FIG. 4 shows an example of a tasks list 400 of a tasks app in the form of a GUI as displayed on a user system, in accordance with some implementations. In FIG. 4, Bob Smith, a licensed Acme technician with knowledge and skill to repair thermostats using Acme widgets regularly monitors list 400. In FIG. 4, Bob currently has 12 unresolved tasks including tasks 404 and 408. Each task includes at least a portion of the data stored in a database record at 240 of FIG. 2, such as the environmental condition and geographic location. For example, task 404 indicates that a high temperature condition was detected in Moscone Center on the west wing of the third floor at 10:14 am.

In FIG. 4, a link 412 to the specific database record is provided in task 404 for Bob to click or tap through the task to access all of the details stored in the particular database record. In this example, task 404 includes links for Bob to interact with social network feeds in the form of “like” link 416 and “comment” link 420. In this way, for example, when Bob has begun working on a task and wishes to provide updates to concerned users or other individuals, Bob can click or tap like link 416 or comment link 420 to publish information to a feed such as group feed 308 of FIG. 3. In addition, an “update status” link 424 embedded in task 404 of FIG. 4 allows Bob to quickly update the status of the relevant database record. For example, when Bob has finished remedying a problem with a thermostat, Bob can click on update status link 424, causing a pop-up window to be displayed, in which Bob can change the status of the database record from open to closed. In response to such a status update, in one example, another record update 328 of FIG. 3 informing users of the status update is automatically generated and published to feed 308. Returning to FIG. 4, additional tasks, such as task 408, have similar components and functionality as task 404 and can provide access to various database records and feeds for an individual such as Bob to quickly inform users of issues and updates. Task list 400 is regularly updated, as tasks are dealt with, to show only unresolved tasks to an individual such as Bob Smith.

In another example of tasks as system events at 248 of FIG. 2, activity histories can be used to generate one or more tasks. For example, a sequence of user actions recorded as a solution to a temperature condition can be retrieved and assigned as separate tasks to identify each action recommended to resolve a situation. In the example of FIG. 3, when share button 320 is clicked, numbered instructions 332 of knowledge article 312 are assigned as separate tasks to all of the members of Shipwright Team A. The same instructions can be assigned as separate tasks to a support person, a specialized vendor, and/or managers of such personnel depending on the particular implementation.

Another example of a system event determined at 248 of FIG. 2 is the automated interaction with an environmental control system 124 as illustrated in FIG. 1. For example, when a thermostat is configured to be controlled remotely, using a system such as Nest™, control signals can automatically be generated and transmitted to control system 124 using an appropriate API to instruct the system to adjust a thermostat and regulate a temperature in response to data recorded in a database record. Also or alternatively, a routine may be programmed to automatically and directly interact with a device such as a thermostat based on a temperature reading, by way of illustration. To this end, in addition to having a communications channel configured between environmental sensors 104 and an environmental monitoring server 112, as shown in FIG. 1, an additional channel can be configured between a server in system 100 and an environmental control system 124 to allow servers in system 100 to send instructions to system 124 to cause adjustments to devices to be made. An API can be programmed to operate an HVAC controller, by way of example, through programmed instructions configured and implemented at a server in system 100. In one example, a number of Nest™ APIs exist for handling appliance and device automation, including thermostat control. Through Nest™ specific commands can be sent from a server in system 100 to a device such as a light dimmer 140, a switch 144 or a thermostat 148, as shown in FIG. 1. Various other devices, machines, appliances, and systems such as office security systems with badges granting access to certain floors and/or regions of a building can be controlled in a similar fashion.

Returning to FIG. 1, the type of system or device to be controlled can vary across implementations and need not be limited to environmental control system 124, light dimmer 140, switch 144 or thermostat 148, as shown in FIG. 1. Other non-limiting examples of such systems or devices include a stove, a lamp, an irrigation system, a lock, a television or monitor, a computing peripheral such as a printer, a modem, a router, a camera, a computing device such as a desktop computer, laptop, tablet, smartphone, a television set-top box, or a wearable device such Google Glass® or other human body-mounted display apparatus.

While the specific inner-workings of a device to be controlled can vary, network interfaces provide the capability for a database system server to send commands over a data network such as the Internet, a cellular network, a Wi-Fi local area network, a Bluetooth private network, or some combination thereof. Alternatively, a device can have a direct, wired or wireless, connection to a server of database system 100.

In the example of FIG. 1, environmental monitoring server 112 can interface with a commercially available environmental control system 124 such as Nest®, American District Telegraph (ADT) Pulse®, Comcast XFINITY Home®, NXP JenNet-IP® network layer software, etc. Such environmental control systems can be used to communicate with commercially available devices to be controlled such as a Nest® thermostat, a Dropcam® Camera, an August Smart Lock®, GreenChip® Smart Lighting, etc. A database connection can be built and opened to allow environmental monitoring server 112 to communicate with a Nest® server and vice versa. Thus, database system 100 can instruct the Nest® server to change operational attributes of a device, such as increasing the value of a temperature parameter.

In some implementations, database system 100 can communicate with a device to be controlled via a number of intermediary nodes. By way of example, the device might be a GreenChip® Smart Lamp containing a 2.4-GHz Institute of Electrical and Electronics Engineers (IEEE) 802.15.4 standard-compatible wireless microcontroller. A database system can indirectly transmit signals to the wireless microcontroller of the device via a number of network devices such as servers, network bridges, routers, switches, etc.

Additionally, a device to be controlled can contain an event performance module for performing events. For instance, such an event performance module might contain hardware, software and/or firmware configured to respond to signals received from a database system. By way of illustration, a device to be controlled can be a lamp containing a GreenChip® enabled Light Emitting Diode (LED) light bulb. An internal event performance module can contain an SSL210x driver configured to increase or decrease the flow of electrical current to the light bulb in response to receiving an appropriate signal to do so from a database system 100.

Returning to FIG. 2, at 256, any system event or sequence of system events determined at 248 can be performed or scheduled to be performed. For example, in FIG. 1, one or more of the servers of database system 100 can cooperate to perform such system events or cause events to be performed. It can be desirable in some implementations to postpone the performance of system events by scheduling system events as part of a batch job to be handled at off-peak hours of system activity.

At 264 of FIG. 2, a server in database system 100 of FIG. 1 receives information indicating that a system event has been performed. For example, in FIG. 3, an update to the status of a database record associated with a high temperature condition from “Open” to “Closed” as shown in record update 328 can be processed at 264. In some implementations, the status of the database record is maintained as a field of the record; that is, the field can be updated to reflect changes to the record's status. By the same token, a social media message from a user with content indicating that a problem has been addresses or remedied can be identified at 264, for example, using keyword filtering of such a message. In another example, at 264, updated environmental data reported to server 112 of FIG. 1 from the same sensor or sensors linked with a previous environmental condition can indicate that a problem has been resolved.

At 272 of FIG. 2, when it is determined that an environmental condition has been addressed, at 280, CRM server 116 of FIG. 1 can automatically update the status of a database record accordingly. Thus, returning to the example of FIG. 3, in some implementations, record update 328 is automatically generated and published in response to environmental monitoring server 112 in FIG. 1 detecting that the temperature in a certain area of a building has been lowered. At 288 of FIG. 2, notifications such as record update 328 can be shared, for example, as published in feed 308 or in other communication channels such as a mobile computing notifications, email, text message, IM, etc.

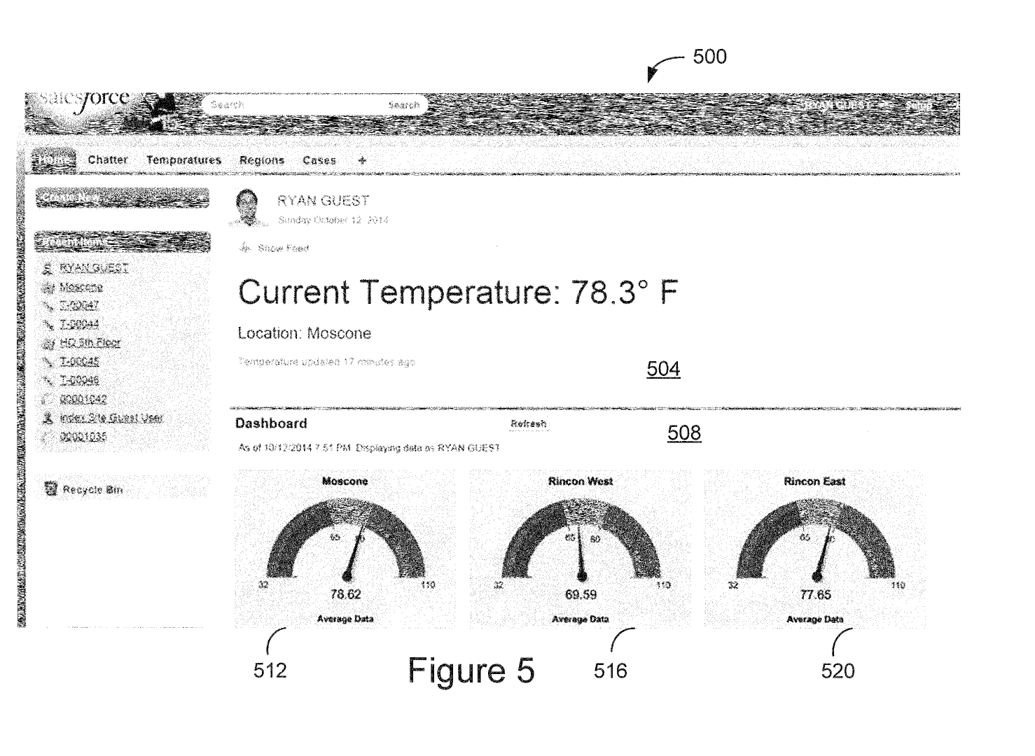

FIG. 5 shows an example of a temperature monitoring window 500 with dashboard components in the form of a GUI as displayed on a user system, in accordance with some implementations. FIG. 5 provides another example of one or more system events capable of being performed or scheduled to be performed, as described above at 248 of FIG. 2, in response to the creating or updating of database records to reflect environmental data and/or environmental conditions.

In FIG. 5, window 500 includes a “current temperature” region 504 displaying in near real-time temperature being monitored by a temperature sensor at a geographic location, such as the rooftop of Moscone Center. In addition, window 500 includes a dashboard region 508 showing more granular temperature readings at specific locations in downtown San Francisco. In particular, pane 512 is a dashboard representing the temperature on the ground floor lobby of Moscone Center, while pane 516 is a dashboard showing the temperature on the west wing of Rincon Center, a different office building from Moscone Center. Pane 520 shows a temperature reading on the east wing of Rincon Center. In some instances, the temperature readings displayed in panes 512-520 are in near real-time, similar to region 504 of FIG. 5. In some implementations, the temperature readings displayed in panes 512-520 reflect temperature data stored in a database record in response to the detecting of environmental conditions, as described above with reference to FIGS. 1-3. In this way, a user such as Ryan Guest having an office located in Moscone Center can personally monitor environmental conditions at those locations. By the same token, window 500 can automatically be generated and displayed to service personnel, security personnel, managers and other individuals interested in monitoring and addressing environmental conditions in certain areas.

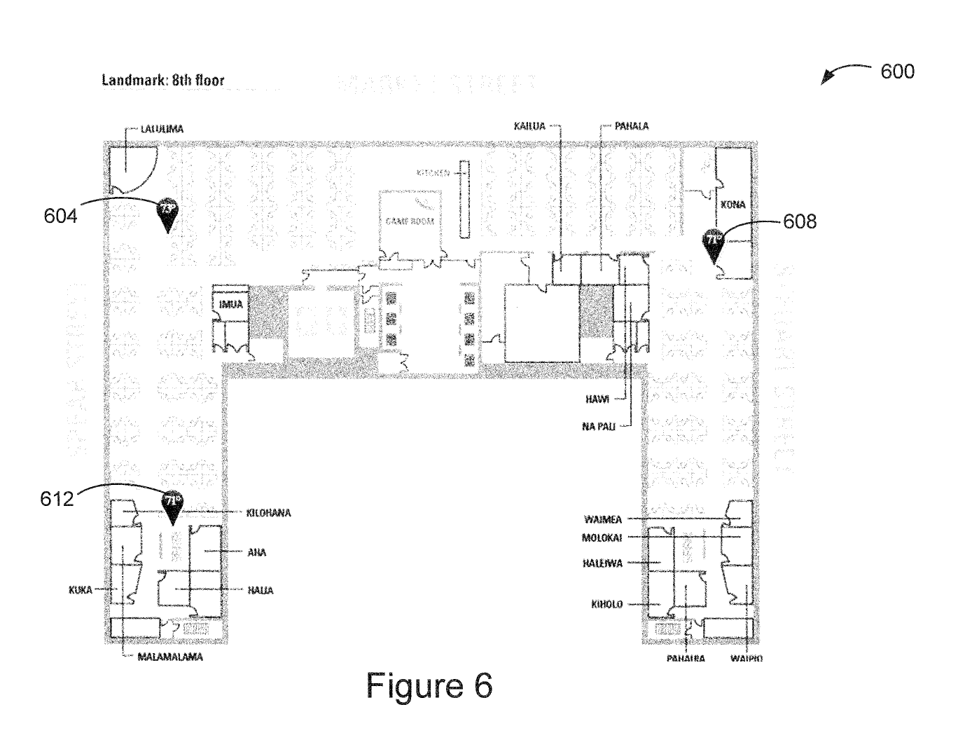

FIG. 6 shows an example of an interactive map 600 of a floor of an office building in the form of a GUI as displayed on a user system, in accordance with some implementations. In FIG. 6, map 600 can be generated as another example of a system event determined at 248 of FIG. 2. Map 600 is generated to graphically represent location data in association with environmental data and/or an environmental condition. In this example, map 600 illustrates the 8th floor of the Landmark building in San Francisco, Calif. A first temperature sensor 604 is deployed immediately outside of the Laluuma conference room. Another temperature sensor 608 is deployed in the Kona room, while another temperature sensor 612 is deployed immediately outside of the Kilohana room. Thus, each sensor 604, 608 or 612 is identifiable as linked with a specific geographic location on the 8th floor of the Landmark building. Each temperature sensor is graphically represented as a drop pin containing a temperature reading identified by temperature data conveyed to an environmental monitoring server 112 of FIG. 1 as described above. Thus, a user viewing map 600 can monitor temperatures at different corners of the 8th floor of the Landmark building in the same user interface. For example, when map 600 is generated and displayed to service personnel and/or security personnel, such individuals can identify isolated or more generalized problem areas and make additional assessments by comparing temperature readings in one region of the floor with readings in other regions.

In FIG. 6, in some implementations, the drop pins graphically representing sensors 604-612 can be color-coded or have other graphical highlights to indicate when temperature data is inside or outside of an acceptable range. For example, a green pin can indicate that the temperature detected by the corresponding sensor is within an acceptable range, while a red pin can indicate that temperature detected by that sensor is too hot. In some implementations, map 600 is provided as one pane or window of a larger user interface with other windows providing additional information of interest, such as live video feeds of security cameras deployed on the floor.

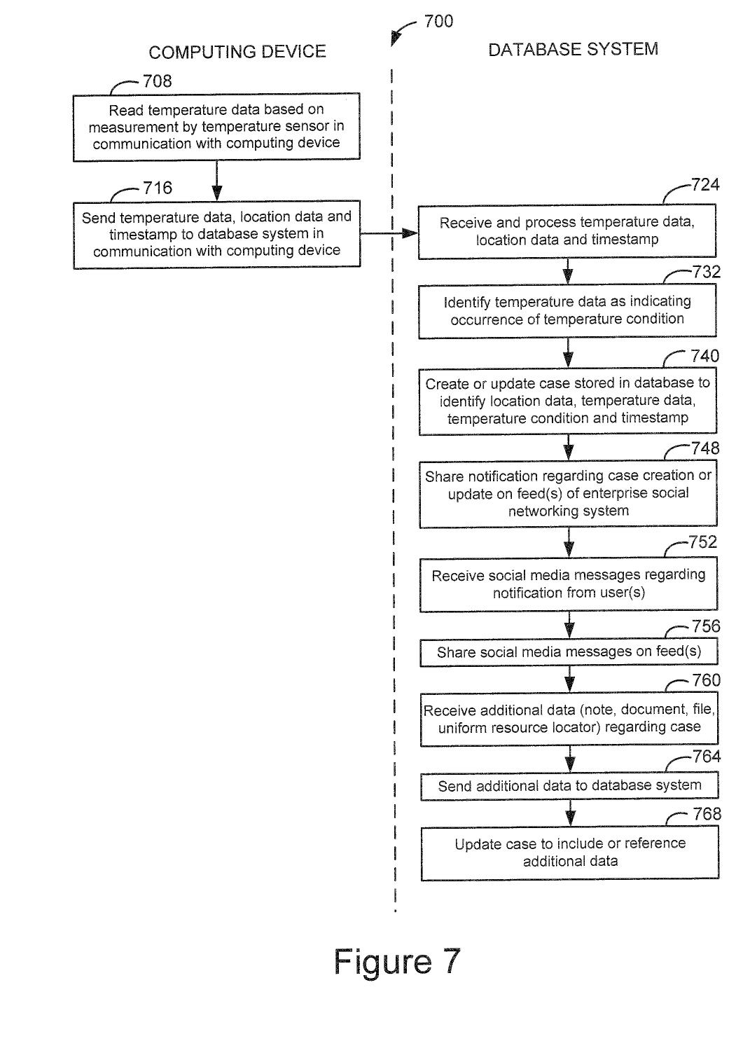

FIG. 7 shows a flowchart of an example of a method 700 for using a database system to automatically cause one or more system events to be performed in response to temperature sensing, in accordance with some implementations. In FIG. 7, at 708, a computing device 108 of FIG. 1 interacts with a temperature sensor, which is one of environmental sensors 104, to read temperature data based on measurements by the temperature sensor. The computing device 108 and/or temperature sensor are configured to attach a timestamp to the reading of 708, for example, in the form of metadata bundled with temperature data and location data. At 716 of FIG. 7, computing device 108 of FIG. 1 transmits the temperature data, timestamp indicating the time of the reading and location data to environmental monitoring server 112 of database system 100.

In FIG. 7, at 724, environmental monitoring server 112 of system 100 is configured to process the temperature data, timestamp and location data. For example, environmental monitoring server 112 can store part or all of such data in environmental database 136. At 732 of FIG. 7, environmental monitoring server 112 is configured to identify the occurrence of a high temperature or low temperature condition based on the temperature data, for example, when the temperature data indicates that the temperature is higher or lower than a designated range or threshold.

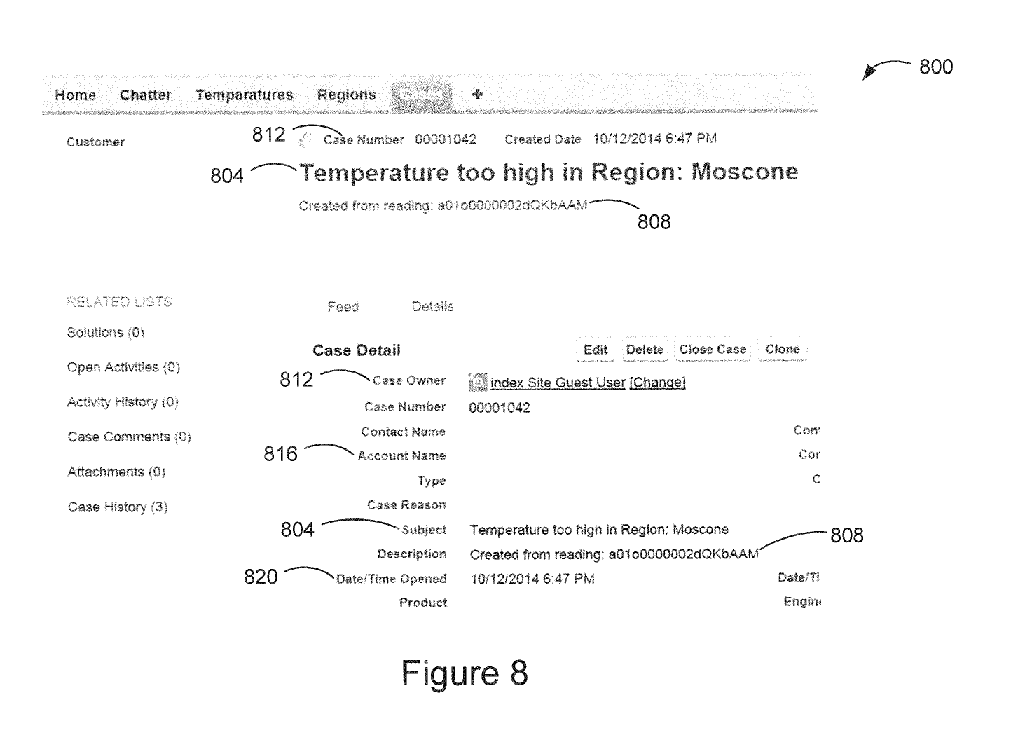

In FIG. 7, at 740, environmental monitoring server 112 informs CRM server 116 of the condition so that CRM server 116 can create or update a case stored in CRM database 128. FIG. 8 shows an example of a database record in the form of a case 800 as presented in a GUI displayed on a user system, in accordance with some implementations. A shown in FIG. 8, a title 804 of the case describes the high temperature condition and a general location of the temperature reading as being in Moscone Center. A reading ID 808 provides a link which a user can click through to access details describing the particular geographic location of the temperature sensor, the timestamp of the reading, and the temperature data processed at 724 of FIG. 7. For example, such information can be stored in a database record of environmental database 136 of FIG. 1. A case number 812 of FIG. 8 provides a case ID for indexing and quickly identifying the particular case in CRM database 128 of FIG. 1. Case detail fields of the case in FIG. 8 include an account name 816 identifying the organization maintaining offices on the 3rd floor of Moscone Center or identifying some other database object having a hierarchical relationship with the case at hand. Additional case detail fields include date/time opened 820, which indicates the date/time the case was opened.

Returning to 740 of FIG. 7, updating a database record such as a case can include escalating or de-escalating the case among priority levels. For example, when a high temperature condition is detected, it can be desirable to escalate a case from low priority to high priority, causing additional notifications to be published to a feed or otherwise communicated to service personnel to indicate the urgency of resolving the high temperature condition. Those skilled in the art should appreciate that “priority” can be an additional case detail field contained within a case as illustrated in FIG. 8. Priority fields can be standard fields in a standard case structure and can be manipulated to respond to additional readings. For example, when a second case is created indicating an even higher temperature in a different region of Moscone Center, the priority of the case in FIG. 8 can be reduced, for example, from high to medium or high to low.

In FIG. 7, at 748, the creating or updating of a case by CRM server 116 of FIG. 1 can be relayed to enterprise social networking server 120, allowing social networking server 120 to generate and publish a notification regarding the record on one or more appropriate feeds of an enterprise social networking system. For example, returning to FIG. 3, record update 304 indicating a high temperature condition and the case number in which additional details regarding the condition are stored is published to feed 308. By the same token, when the high temperature problem has been resolved, record update 328 indicates that the case has been updated to have a status of closed rather than open, as shown in feed 308.

In FIG. 3, by using feed 308, appropriate users can be notified of environmental conditions, such as high temperature and low temperature conditions. For example, since feed 308 is dedicated to the Shipwright Team A group, whose workspaces are located on the west wing, 3rd floor of Moscone Center, record updates published to feed 308 can serve to quickly notify and initiate conversations among those employees who are members of the Shipwright Team A group. For example, a user such as Eric Yip can click on a link 336 to the case to access information and details as described above with respect to FIG. 8. Thus, Eric and other users can quickly learn that the high temperature condition has at least been detected and can engage in conversations to determine whether the problem has been resolved. For example, Eric can submit a post 340, in response to which other users can comment as illustrated by comments 344 and 348 of FIG. 3. If Eric or another user wishes to take further action, in the example of FIG. 3, Eric can click on an “IM” link 352 or “email” link 356 to automatically generate an instant message or email window, allowing Eric to compose and send a message to an individual such as Bob the technician. By the same token, using IM link 352 or email link 356, a user such as Eric can attach a knowledge article or other detailed instructions regarding how to solve a problem such as a high temperature condition.

In some implementations in which Chatter is used, various CRM objects can be linked with cases, groups and other entities identified in a database system such as system 100 of FIG. 1. For example, an account linked with the case or cases identified in record updates 304 and 328 of FIG. 3 could be accessed to view additional details. Also or alternatively, a case feed dedicated to a case as identified in record updates 304 and 328 can be provided. Thus, by clicking on a tab or other link in a user interface to access and display the case feed, a user can quickly retrieve all of the record updates and conversations such as posts, comments, likes, etc. relevant to the specific case that was created or updated. By the same token, users can subscribe to the case to automatically receive any updates regarding the case such as field changes, status changes, social media messages, etc. in the user's news feed. Status updates can inform various status changes in addition to a case being opened or closed, such as a status of “waiting”, e.g., for an outside vendor to deliver a part or for a service technician to indicate that a thermostat has been repaired. When the case changes status from open to closed, indicating that a temperature issue has been resolved, record update 328 as described above with reference to FIG. 3 would also be shared on the designated case feed. There can also be a case history, showing all of the various changes a case went through in its life cycle as a CRM object in database 128 of FIG. 1.

Returning to FIG. 7, at 752, social media messages regarding a record update informing the creating or updating of a case, as described above, can be received from various users. Thus, employees such as Eric Yip, Spencer Scorcelletti and Ronald Liu can submit posts and comments as illustrated in feed 308 of FIG. 3, that is, after such users click a “share” or “publish” button in a user interface, causing a social networking server 120 of FIG. 1 to publish those social media messages at 756 of FIG. 7. In the example of FIG. 3, any members of the Shipwright Team A group can then quickly digest information and collaborate as part of a conversation about environmental conditions reported using record updates.

At 760 of FIG. 7, using publisher 316 of FIG. 3 or another mechanism, users can submit various data such as notes, documents, files, and uniform resource locators (URLs) regarding a case identified in a feed. This way, various users can add notes to a case. Such notes can be stored in or linked with a case. For example, a note could be added to a case to indicate that a high temperature condition has been communicated to a service technician. In another example, a service technician can add a note to a case indicating that a replacement part has been ordered and should be received from a supplier within 5 to 7 days. In some implementations, appropriate authorization profiles are maintained so certain users having certain roles or positions in an organizational hierarchy may be permitted to access and edit a case, while other users would be provided with read-only access. By the same token, knowledge articles as described above and illustrated in FIG. 3 can be linked with a case. Various other documents and files can be attached to a case, such as a digital image of a broken part.

Addition data received at 760 of FIG. 7 can then be transmitted to a server of database system 100 of FIG. 1 at 764 of FIG. 7. At 768, a CRM server 116 of FIG. 1 can then update the case in CRM database 128 to include or reference the additional data. Various other database records stored in CRM database 128 or in other databases of database system 100 can be identified as storing or referencing the same location data as a given case, and such additional records can be linked with the created or updated case for access and processing using database system 100.

Some non-limiting examples of systems, apparatus, and methods are described below for implementing database systems and enterprise level social networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

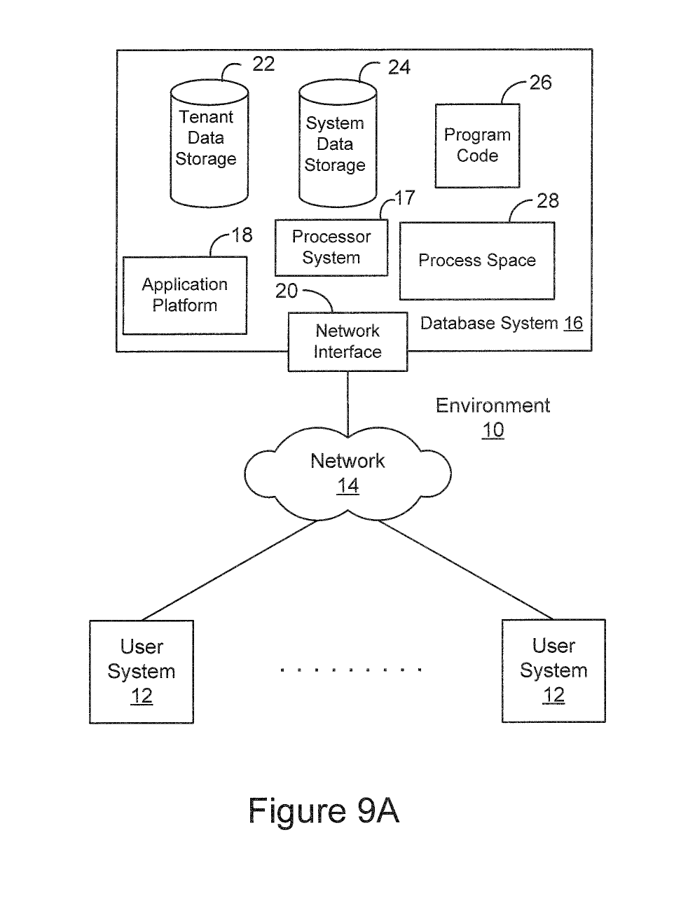

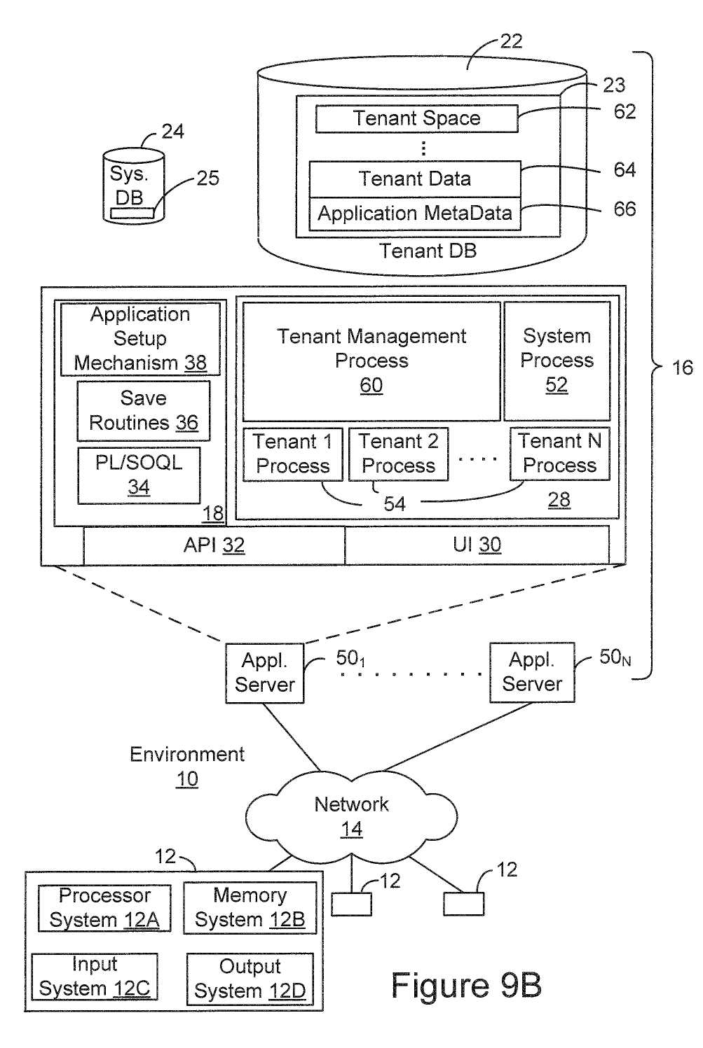

FIG. 9A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 9A (and in more detail in FIG. 9B) user systems 12 might interact via a network 14 with an on-demand database service, which is implemented in the example of FIG. 9A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 9A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 9A and 9B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 9A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 9B shows a block diagram of an example of some implementations of elements of FIG. 9A and various possible interconnections between these elements. That is, FIG. 9B also illustrates environment 10. However, in FIG. 9B elements of system 16 and various interconnections in some implementations are further illustrated. FIG. 9B shows that user system 12 may include processor system 12A, memory system 12B, input system 12C, and output system 12D. FIG. 9B shows network 14 and system 16. FIG. 9B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 9A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 9B, system 16 may include a network interface 20 (of FIG. 9A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

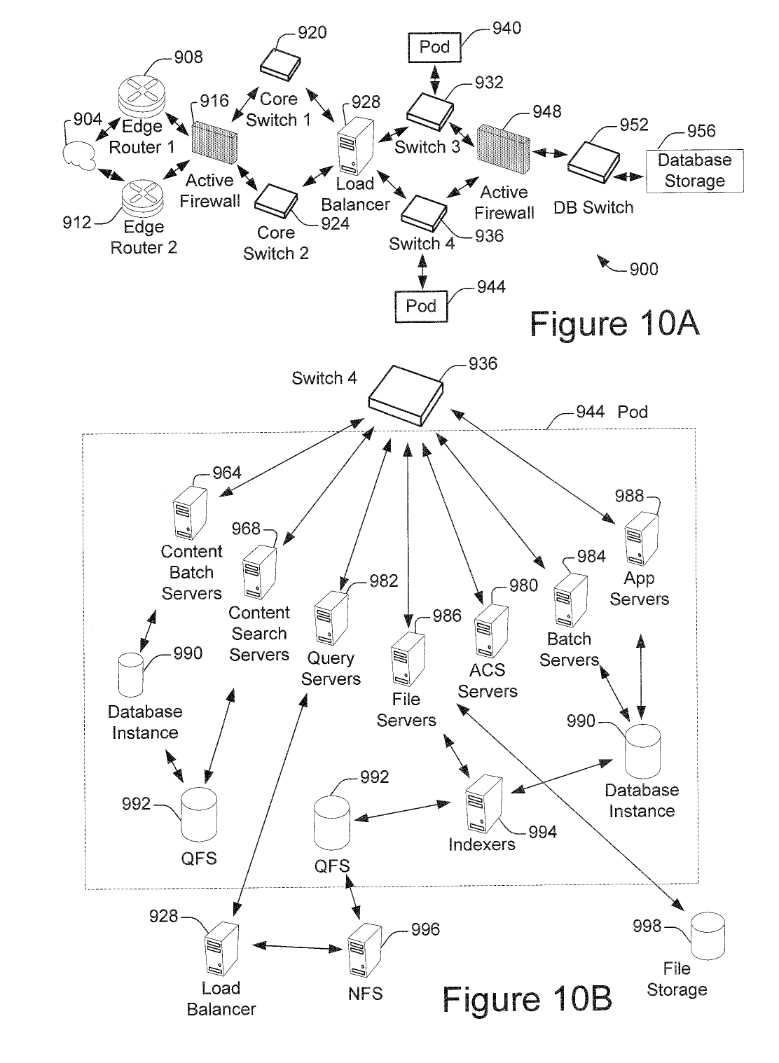

FIG. 10A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 10A and 10B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 10A and 10B, some implementations of an on-demand database service environment may include anywhere from one to many devices of each type. Also, the on-demand database service environment need not include each device shown in FIGS. 10A and 10B, or may include additional devices not shown in FIGS. 10A and 10B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 10B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 10A and 10B.

FIG. 10B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of one or more app servers 988 is configured to execute operations of one or more servers of database system 100 of FIG. 1 as described herein, including performance of one or more of the operations of methods described herein with reference to FIGS. 1-8. In alternative implementations, two or more app servers 988 may be included to perform such methods, or one or more other servers described herein can be configured to perform part or all of the disclosed methods.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system configurable to:
receive environmental data and location data from a computing device capable of reading the environmental data using at least one environmental sensor capable of monitoring at least one environmental characteristic of a physical environment, the at least one environmental sensor capable of communicating the at least one monitored environmental characteristic to the computing device, the at least one environmental sensor capable of being situated at a geographic location identifiable by the location data;
determine, using the environmental data, an occurrence of an environmental condition;
create or update, responsive to determining the occurrence of the environmental condition, a database record in a database, the created or updated database record identifying the location data and at least one of the environmental data or the environmental condition;
determine, based on the creating or updating of the database record, at least one system event to perform; and
cause the at least one system event to be performed or scheduled to be performed.

2. The database system of claim 1, wherein the system event comprises sharing an electronic notification regarding the creating or updating of the record on at least one feed of an enterprise social networking system, the database system further configurable to:
receive at least one social media message regarding the notification from at least one user of the social networking system; and
share the at least one social media message on the at least one feed, the at least one social media message capable of being accessed and commented on by other users of the social networking system using the at least one feed.

3. The database system of claim 1, wherein the at least one system event comprises at least one of: identifying at least one user as being relevant to the geographic location and/or to the environmental condition, sharing an electronic notification of the creating or updating of the record with at least one user, determining and/or generating an electronic task associated with the database record, assigning an electronic task associated with the database record to at least one user, displaying the location data in association with the environmental data and/or with the environmental condition in a user interface on a display of a user system, identifying a knowledge article relevant to the database record and linking the knowledge article to the database record, interacting with an environmental control system, interacting with an environmental control device, interacting with a building security system, sending a command to an appliance, or sending a command to a device.

4. The database system of claim 1, the database system further configurable to:
receive information indicating that the system event has been performed;
determine that the environmental condition has been addressed;
update a status of the database record to indicate that the environmental condition has been addressed; and
share an electronic notification indicating the updated status on at least one feed of an enterprise social networking system.

5. The database system of claim 1, wherein updating the database record comprises escalating or de-escalating the database record from a first priority to a second priority.

6. The database system of claim 1, wherein determining the occurrence of the environmental condition comprises:
determining that the environmental data traverses a specified threshold and/or is outside of a specified range.

7. The database system of claim 1, the database system further configurable to:
receive a timestamp from the computing device, the timestamp identifying a time of the environmental data reading, the created or updated database record further identifying the timestamp.

8. The database system of claim 1, wherein the at least one environmental sensor comprises at least one of: a temperature sensor, a humidity sensor, or a light sensor, and wherein the environmental data comprises at least one of: temperature data, humidity data, or light data.

9. The database system of claim 1, wherein the geographic location comprises at least one of: Wi-Fi coordinates, global positioning system (GPS) coordinates, a network address, a street address, a floor of a building, or a region of a building.

10. The database system of claim 1, the database system further configurable to:
receive additional data regarding the database record, the additional data comprising at least one of: a note, a document, a file, or a uniform resource locator (URL); and
update the database record to include or reference the additional data.

11. The database system of claim 1, the database system further configurable to:
identify at least one further database record associated with the location data; and
link the created or updated database record with the at least one further database record.

12. The database system of claim 1, wherein the database record is a customer relationship management (CRM) record in the form of a case associated with an account identifying at least one of: an organization, a building, a street address, a city, a state or a geographic region.

13. The database system of claim 1, wherein the computing device is a mobile computing device.

14. The database system of claim 1, wherein the database system is a multi-tenant database system, the database record being associated with a tenant of the database system, the tenant being an organization.

15. A system comprising:
database system software stored on at least one non-transitory data storage medium for execution by at least one server of a database system, the database system software operable to cause:
determining, using environmental data, an occurrence of an environmental condition, the environmental data and location data being receivable from a computing device capable of reading the environmental data using at least one environmental sensor capable of monitoring at least one environmental characteristic of a physical environment, the at least one environmental sensor capable of communicating the at least one monitored environmental characteristic to the computing device, the at least one environmental sensor capable of being situated at a geographic location identifiable by the location data,
creating or updating, responsive to determining the occurrence of the environmental condition, a database record in a database, the created or updated database record identifying the location data and at least one of the environmental data or the environmental condition,
determining, based on the creating or updating of the database record, at least one system event to perform, and
causing the at least one system event to be performed or scheduled to be performed.

16. The system of claim 15, wherein the system event comprises sharing an electronic notification regarding the creating or updating of the record on at least one feed of an enterprise social networking system, the database system software further operable to cause:
sharing at least one social media message regarding the notification on the at least one feed, the at least one social media message received from at least one user of the social networking system, the at least one social media message capable of being accessed and commented on by other users of the social networking system using the at least one feed.

17. The system of claim 15, wherein the at least one system event comprises at least one of: identifying at least one user as being relevant to the geographic location and/or to the environmental condition, sharing an electronic notification of the creating or updating of the record with at least one user, determining and/or generating an electronic task associated with the database record, assigning an electronic task associated with the database record to at least one user, displaying the location data in association with the environmental data and/or with the environmental condition in a user interface on a display of a user system, identifying a knowledge article relevant to the database record and linking the knowledge article to the database record, interacting with an environmental control system, interacting with an environmental control device, interacting with a building security system, sending a command to an appliance, or sending a command to a device.

18. The system of claim 15, the database system software further operable to cause:
determining that the environmental condition has been addressed,
updating a status of the database record to indicate that the environmental condition has been addressed, and
sharing an electronic notification indicating the updated status on at least one feed of an enterprise social networking system.

19. A method for using a database system to cause automated system events to be performed in response to environmental sensing, the method comprising:
receiving, at a database system, environmental data and location data from a computing device configured to read the environmental data using at least one environmental sensor configured to monitor at least one environmental characteristic of a physical environment, the at least one environmental sensor situated at a geographic location identified by the location data;
identifying, using the database system, the environmental data as indicating occurrence of an environmental condition;
creating or updating, responsive to identifying the environmental data as indicating the occurrence of the environmental condition, a database record in the database system, the created or updated database record identifying the location data and at least one of the environmental data or the environmental condition;
determining, using the database system, at least one system event to perform based on the creating or updating of the database record; and
causing the at least one system event to be performed or scheduled to be performed.

20. The method of claim 19, wherein the at least one system event comprises at least one of: identifying at least one user as being relevant to the geographic location and/or to the environmental condition, sharing an electronic notification of the creating or updating of the record with at least one user, determining and/or generating an electronic task associated with the database record, assigning an electronic task associated with the database record to at least one user, displaying the location data in association with the environmental data and/or with the environmental condition in a user interface on a display of a user system, identifying a knowledge article relevant to the database record and linking the knowledge article to the database record, interacting with an environmental control system, interacting with an environmental control device, interacting with a building security system, sending a command to an appliance, or sending a command to a device.
